(19) United States
(12) Patent Application Publication
(10) Pub. No.: US 2014/0257980 A1
(43) Pub. Date: Sep. 11, 2014

(54) DISPLAYING PROMOTION INFORMATION

(71) Applicant: Alibaba Group Holding Limited, Grand Cayman (KY)

(72) Inventors: Weidong Yin, Hangzhou (CN); Xiaonan Meng, Hangzhou (CN); Zhuo Wang, Hangzhou (CN); Xiaojian Li, Hangzhou (CN)

(73) Assignee: Alibaba Group Holding Limited, Grand Cayman (KY)

(21) Appl. No.: 14/186,762

(22) Filed: Feb. 21, 2014

(30) Foreign Application Priority Data
Mar. 7, 2013 (CN) 201310073113.X

(51) Int. Cl. G06Q 30/02

(52) U.S. Cl. CPC G06Q 30/0255
USPC 705/14.53

(57) ABSTRACT

The present disclosure discloses an example method and apparatus for displaying promotion information. Multiple preferences and a respective weight of each preference of a user at a client terminal that visits a current page are obtained. A respectively assigned number of display locations for each preference is calculated based on the respective weight of each preference and a number of display locations at the current page. Respective promotion information corresponding to a respective reference is obtained. Promotion information is displayed at the display locations of the current page according to the respectively assigned number of display locations for each preference. The present techniques improve diversity of results in the direction technology.

### CROSS REFERENCE TO RELATED PATENT APPLICATIONS

This application claims foreign priority to Chinese Patent Application No. 201310073113.X filed on 7 Mar. 2013, entitled “Method and Apparatus for Displaying Promotion Information,” which is hereby incorporated by reference in its entirety.

### TECHNICAL FIELD

The present disclosure is related to the Internet, and, more particularly, to a method and an apparatus for displaying promotion information.

### BACKGROUND

With the rapid development of network media, more and more network information promotion techniques are appearing. A trend of accurately promoting network information helps the development of direction technology. The direction technology finds a most suitable user given a context and promotion information. In other words, the direction technology selects target users (who are Internet users that have access to the promotion information). With the direction technology, a party sending promoting information may accurately display the promotion information based on a population attribute, a geographical location attribute, behavior preference, and a social attribute of users, thereby displaying the promotion information to the target users to improve a direction of promotion, save a promotion budget, and increase an investment return.

It is very important to increase diversity of the promotion information to attract the users. Monotonous promotion information transmits few contents to the users and attracts few interests of the users. For example, the direction technology may determine that a user preference of the target users is lunch box and an advertisement full of lunch boxes may be displayed. The user preference may be analyzed by the direction technology based on a cookie. There may be various methods to represent the user preference, such as a preference keyword, a preferred category, or a preferred advertisement.

In the conventional direction technology, the advertisements are searched by a search engine according the user preference. The user may have multiple preferences that are ranked from high to low. When results satisfying a first preference are sufficient to fill in advertisement locations, the displayed advertisements are monotonous.

The conventional direction technology thus has at least the following disadvantages. First, the information is monotonous and the information volume is limited. Second, the conventional direction technology cannot satisfy real requirements of the target users. As the user preference may change over time, monotonous results are difficult to meet the requirements of the users. Third, the conventional direction technology has difficulty locating the target users in a long term as received click feedbacks are declining.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-readable instructions as permitted by the context above and throughout the present disclosure.

The present techniques improve diversity of results in the direction technology.

The present disclosure provides an example method for displaying promotion information. Multiple preferences and a respective weight of each preference of a user at a client terminal that visits a current page are obtained. For example, the preferences may be obtained according to a user cookie at the client terminal. A respectively assigned number of display locations for each preference is calculated based on the respective weight of each preference and a number of display locations at the current page. Respective promotion information corresponding to a respective reference is obtained. Promotion information is displayed at the display locations of the current page according to the respectively assigned number of display locations for each preference.

For example, promotion information may be displayed at the display locations of the current page according to the respectively assigned number of display locations for each preference according to following operations. The respective appearance number of display locations for the respective promotion information corresponding to the respective preference may be adjusted based on the respectively assigned number of display locations for the respective preference and a respective number of promotion information that is actually obtained or obtainable corresponding to the respective preference. A corresponding number of promotion information for the respective preference is displayed at the display locations according to the adjusted respective appearance number of display locations for the respective preference.

For example, the respectively assigned number of display locations for each preference may be calculated based on the respective weight of each preference and the number of display locations at the current page according to following operations. A particular preference is pre-selected from the obtained preferences. With respect to the other preferences, the respective weight of the respective preference is divided by a sum of weights of all preferences. The obtained quotient multiplies the number of display locations at the current page. The obtained product is rounded down. The result is used as the respectively assigned number of display locations of the respective preference. The number of display locations minus the sum of the respectively assigned number of display locations of the other preferences to obtain the respectively assigned number of display locations for the particular preference.

For example, the respective promotion information corresponding to the respective reference may be obtained according to following operations. The respective promotion information corresponding to each preference may be obtained in parallel.

For example, the respective appearance number of display times for the respective promotion information corresponding to the respective preference may be adjusted based on the respectively assigned number of display locations for the respective preference and the respective number of promotion information that is actually obtained or obtainable corresponding to the respective preference according to following operations. With respect to each preference, the following operations are performed. A lesser number between the respectively assigned number of display locations and the respective number of promotion information that is actually obtainable or obtained is used as the respective appearance number of display locations for the respective promotion information. If the respective number of promotion information that is actually obtainable corresponding to the respective preference is higher than the respectively assigned number of display locations, a difference value is calculated. The difference value is used as a respective difference number corresponding to the respective preference.

A difference between the number of display locations and a sum of the respective appearance number of display locations for each preference is calculated to obtain a display location remaining number. If the display location remaining number is larger than 0 and there exists at least one preference with respective difference number, a particular preference with a respective difference number is selected. The respective appearance number of display locations of the particular preference adds a lesser number between the respective difference number and the display location remaining number to obtain a result to update the respective appearance number of display locations of the particular preference. These operations are performed iteratively. If the display location remaining number is not larger than 0 or there does not exist any respective difference number, the operations that display corresponding number of promotion information at the display locations according to the adjusted respective appearance number of display locations of each preference are performed.

The present disclosure also provides an example apparatus for displaying promotion information. The apparatus may include a preference obtaining module, an assigning module, information obtaining module, and a displaying module. The preference obtaining module obtains multiple preferences and a respective weight of each preference of a user at a client terminal that visits a current page. For example, the preferences may be obtained according to a user cookie at the client terminal. The assigning module assigns a respectively assigned number of display locations for each preference based on the respective weight of each preference and a number of display locations at the current page. The information obtaining module obtains respective promotion information corresponding to a respective reference. The display module displays or pushes promotion information at the display locations of the current page according to the respectively assigned number of display locations for each preference.

For example, the displaying module may include an adjusting unit and a displaying unit. The adjusting unit adjusts a respective appearance number of display locations for the respective promotion information corresponding to the respective preference based on the respectively assigned number of display locations for the respective preference and a respective number of promotion information that is actually obtained or obtainable corresponding to the respective preference. The displaying unit displays a corresponding number of promotion information for the respective preference at the display locations according to the adjusted respective appearance number of display locations for the respective reference.

For example, the assigning module may include a pre-selecting unit, a first calculating unit, and a second calculating unit. The pre-selecting unit pre-selects a particular preference from the obtained preferences. The first calculating unit, with respect to the other preferences, divides the respective weight of the respective preference by a sum of weights of all preferences, multiplies the obtained quotient with the number of display locations at the current page, and uses the obtained product that is rounded down as the respectively assigned number of display locations of the respective preference. The number of display locations minus the sum of the respectively assigned number of display locations of the other preferences to obtain the respectively assigned number of display locations for the particular preference. The second calculating unit subtracts the sum of the respectively assigned number of display locations of the other preferences from the number of display locations to obtain the respectively assigned number of display locations for the particular preference.

For example, the information obtaining module obtains the respective promotion information corresponding to each preference in parallel.

For example, the adjusting unit may include a pre-setting sub-unit, a remaining location calculating sub-unit, a determining sub-unit, and an adjusting sub-unit.

The pre-setting sub-unit, with respect to each preference, performs the following operations. The pre-setting sub-unit uses a lesser number between the respectively assigned number of display locations and the respective number of promotion information that is actually obtained or obtainable as the respective appearance number of display locations for the respective promotion information. If the respective number of promotion information that is actually obtained or obtainable corresponding to the respective preference is higher than the respectively assigned number of display locations, the pre-setting unit calculates a difference value and use the difference value as a respective difference number corresponding to the respective preference.

The remaining location calculating sub-unit calculates a difference between the number of display locations and a sum of the respective appearance number of display locations for each preference to obtain a display location remaining number.

The determining sub-unit starts the adjusting sub-unit if the display location remaining number is larger than 0 and there exists at least one particular preference with respective difference number, or sending the respective appearance number of display locations of the respective preference to the displaying unit if the display location remaining number is not larger than 0 or there does not exist any respective difference number.

The adjusting sub-unit selects a particular preference with a respective difference number, adds the respective appearance number of display locations of the particular preference with a lesser number between the respective difference number and the display location remaining number to obtain a result to update the respective appearance number of display locations for the particular preference, and then instructs the remaining location sub-unit to re-calculate.

At least one example embodiment of the present disclosure changes the conception of the conventional techniques. Instead of filling in the display location with information corresponding to the highest preference, the present techniques provide opportunities of presentation to multiple preferences. Thus, there are multiple display results corresponding to the multiple preferences. The diversity of display results in the direction technology is improved. The click rate and user experience are improved. Another example embodiment of the present disclosure maximally utilizes the result arising from the direction technology and reduces filling in popular keywords, thereby improving the user experiences. Another example embodiment of the present disclosure, according to the principle of preferred weights, assigns the remaining display locations to the preferences with higher weights. Certainly, it is not necessary for any product of the present disclosure to achieve all of the above features.

### BRIEF DESCRIPTION OF THE DRAWINGS

FIG. 1 is a flowchart illustrating an example method for display promotion information according to a first example embodiment of the present disclosure.

FIG. 2 is a schematic diagram illustrating an example system that implements present techniques according to the first example embodiment the present disclosure.

FIG. 3 is a flowchart illustrating an example calculation process according to the first example embodiment of the present disclosure.

FIG. 4 is a schematic diagram illustrating an example apparatus for displaying promotion information according to a second example embodiment of the present disclosure.

### DETAILED DESCRIPTION

The present techniques in the present disclosure are described below in detail by reference to the FIGs and example embodiments. The example embodiments of the present disclosure and the characteristic features thereof may be combined or referenced to each other when there is no conflict and shall still be subject to protection of the present disclosure. In addition, although the flowcharts illustrate certain logical sequences, in some examples, the operations illustrated or shown herein may be performed in some other sequences.

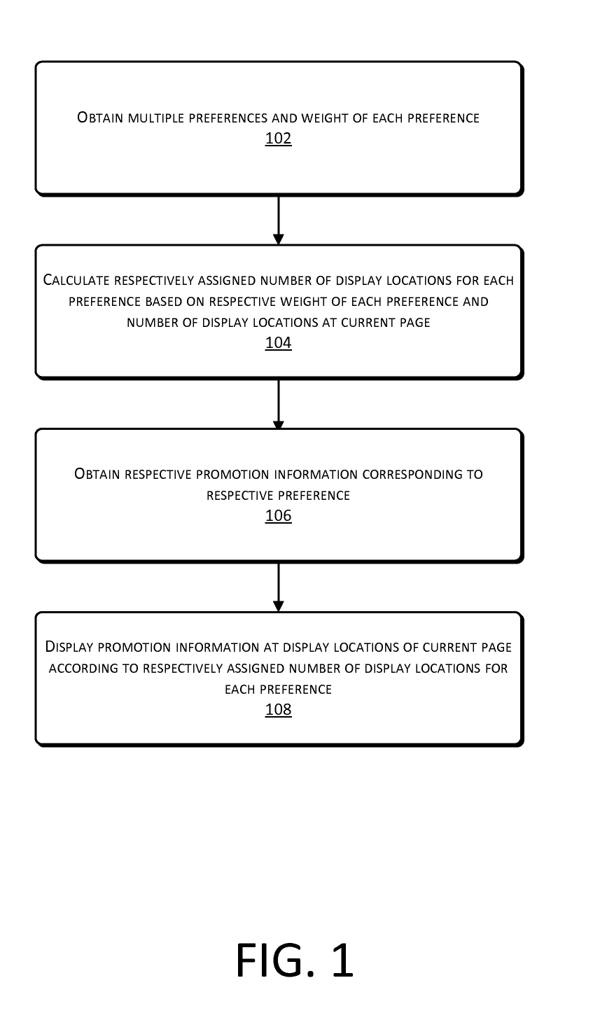

FIG. 1 is a flowchart illustrating an example method for displaying promotion information according to a first example embodiment of the present disclosure.

At 102, multiple preferences and a respective weight of each preference for one or more users are obtained. For example, the multiple preferences and a respective weight of each preference for the one or more users may be obtained according to a user cookie at a client terminal that visits a current page.

At 104, a respectively assigned number of display locations for each preference is calculated based on the respective weight of each preference and a number of display locations at the current page.

At 106, respective promotion information corresponding to a respective preference is obtained.

At 108, the promotion information is displayed at the display locations of the current page according to the respectively assigned number of display locations for each preference.

For example, the operations at 108 may further include the following.

At a first step S41 (not shown in FIG. 1), a respective appearance number of display locations for the respective promotion information corresponding to the respective preference may be adjusted based on the respectively assigned number of display locations for the respective preference and a respective number of promotion information that is actually obtained or obtainable corresponding to the respective preference.

At a second step S42 (not shown in FIG. 1), a corresponding number of promotion information for the respective preference is displayed at the display locations according to the adjusted respective appearance number of display locations for the respective reference.

For another example, the corresponding number of promotion information for the respective preference may be directly requested according to the respectively assigned number of display locations for the respective preference. In such situations, if, with respect to one or more preferences, the respective number of obtained or obtainable promotion information is less than the respectively assigned number of display location, the respective number of promotion information that is actually displayed may be adjusted. When the respective number of obtainable promotion information for the respective preference is insufficient, respective promotion information of some other preference may be obtained for displaying to ensure that each display location has promotion information. Alternatively, the adjustment may not be conducted. The additional display location may be kept blank or used to repeat to display promotion information at another display location.

In one example embodiment, the preferences and their corresponding weights at the cookie of the client terminal may be determined based on the conventional direction technology. For example, certain algorithms are used to determine the preferences and their respective weights corresponding to the cookie based on cookie tracking and statistics of certain user's operations such as browsing, searching, clicking, saving, trading, and feedback.

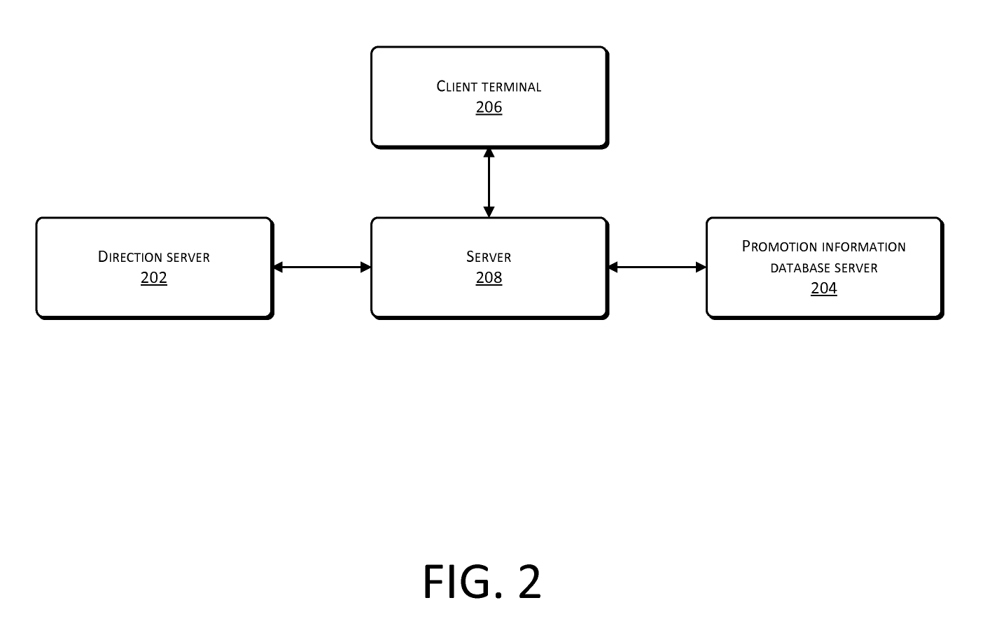

FIG. 2 is a schematic diagram illustrating an example system that implements present techniques according to the first example embodiment of the present disclosure. In an example scenario, a direction server 202 saves the user preferences and weights of each preference. A promotion information database server 204 saves the promotion information corresponding to each preference. When a client terminal 206 visits a page, a server 208 sends cookie information that tracks the user behavior preference to the direction server 202 and saves them at the direction server 202. The server 208, according to the user cookie at the client terminal 206, obtains the preferences and their weights corresponding to the cookie from the direction server 202, and implements a mandatory diversity strategy based on the preferences and their weights. That is, the server 208 may implement the operations at 104. The server 208 sends the preferences to the promotion information database server 204 to search corresponding promotion information, and finally displays them at the client terminal 206 for presentation.

The present techniques in the example embodiment, when using the direction technology to promote information to the user, assigns the respective number of promotion information for the preferences based on the weights of the preference, thereby avoiding uniformity of the promotion information and improving the diversity of the promotion information.

For example, the preferences may include, but are not limited to, one or more preference keywords. The preferences may also be any other representations that represent the user's online behavior characteristics.

In an example embodiment, the operations at 104 may further include the following. A particular preference is pre-selected from the obtained preferences. With respect to the other preferences, the respective weight of the respective preference is divided by a sum of weights of all preferences. The obtained quotient multiplies the number of display locations at the current page. The obtained product is rounded down and the result is used as the respectively assigned number of display locations of the respective preference. The number of display locations minus the sum of the respectively assigned number of display locations of the other preferences to obtain the respectively assigned number of display locations for the particular preference.

The calculation in the example embodiment may be represented by the formula below.

$${n}_{i} = floor ( K \frac{{weight}_{i}}{{\sum }_{j = 1}^{m} {weight}_{j}} ) , \\ i = 1 , 2 , … , m - 1 \\ {n}_{m} = K - {\sum }_{j = 1}^{m - 1} {n}_{j} \qquad ( 1 )$$

nₘ represents the respectively assigned number of display locations for the particular pre-selected preference. floor(•) function represents rounding down a value. For example, floor(3.7)=3. K represents the number of display locations at the current page. m represents the number of obtained preferences. weight, represents a weight of ith preference.

$${\sum }_{j = 1}^{m} {weight}_{j}$$

represents a sum of weights of the obtained m preferences.

$${\sum }_{j = 1}^{m - 1} {n}_{j}$$

represents a sum of the respectively assigned number of display locations of the other preferences.

In this example embodiment, the display locations are linearly allocated according to their weights. In some other alternative example embodiments, some other non-linear methods may be used.

In this example embodiment, the pre-selected particular preference may be any one of the preferences, a preference with the highest weight, a preference with the lowest weight, or any other preference that is pre-selected according to configurations or needs.

For example, the operations at 106 may include the following. The respective promotion information corresponding to each preference may be obtained in parallel.

For example, the operations at S41 may include the following.

At S411 (not shown in FIG. 1), with respect to each preference, the following operations are performed. A lesser number between the respectively assigned number of display locations and the respective number of promotion information that is actually obtained or obtainable is used as the respective appearance number of display locations for the respective promotion information. If the respective number of promotion information that is actually obtained or obtainable corresponding to the respective preference is higher than the respectively assigned number of display locations, a difference value is calculated. The difference value is used as a respective difference number corresponding to the respective preference.

At S412 (not shown in FIG. 1), a difference between the number of display locations and a sum of the respective appearance number of display locations for each preference is calculated to obtain a display location remaining number. If the display location remaining number is larger than 0 and there exists at least one preference with respective difference number, a particular preference with a respective difference number is selected. The respective appearance number of display locations of the particular preference adds a lesser number between the respective difference number and the display location remaining number to obtain a result to update the respective appearance number of display locations of the particular preference. These operations at 5412 are performed iteratively until the display location remaining number is not larger than 0 or there does not exist any respective difference number. Then the operations at S42 are performed.

In the example, if there are two or more preferences that have respective difference numbers, the particular preference with the respective difference number may be selected according to, but not limited to, a principle of weight priority. The promotion information corresponding to the particular preference that has higher weight is assigned to the remaining display locations.

An example detailed implantation of the present techniques is as follows. One or more direction characteristic of the user is searched according to the user cookie at the client terminal (such as a web browser) that visits the current webpage. The direction characteristics include the preferences of the user and their weights.

For example, a cookie may be identified as xyz and the preferences corresponding to the xyz may be obtained. The preferences may include a cell phone case, a non-woven bag, and a shrilling chick. The weights corresponding to the references are as follows.

A weight of the cell phone case is 4.0.

A weight of the non-woven bag is 3.4.

A weight of the shrilling chick is 2.1

Assuming that the number of display locations K at the current page is 18, the pre-selected preference is the shilling chick. According to the above formula (I), the respectively assigned number of display location for each preference is as follows.

The respectively assigned number of display locations of the cell phone case is floor(18×4/(4+3.4+2.1))=floor(7.579)=7.

The respectively assigned number of display locations of the non-woven bag is floor(18×3.4/(4+3.4+2.1))=floor(6.442)=6.

The respectively assigned number of display locations of the shrilling bag is 18−(7+6)=5.

Each of the three references may be regarded as a group. The respectively assigned number of display location obtained from the above method may be used as an expected number of promotion information for the group.

The server that provides the promotion information may be visited in parallel according to the above three preferences. The number of the returned promotion information for each preference is required to be not higher than the number of display locations K at the current page. In an example application scenario, the number of actually returned promotion information is generally not equal to the expected number of promotion information nᵢ. The respective number of actually returned promotion information for the ith preference is represented by cᵢ, i=1, 2, 3, . . . , m.

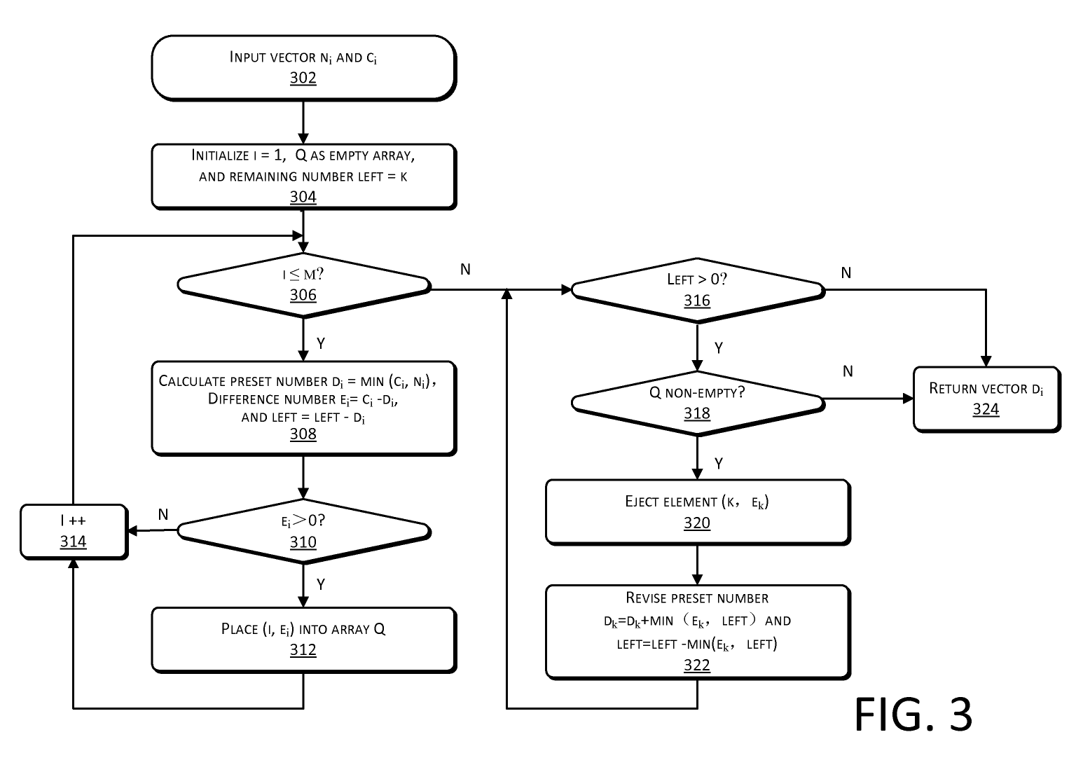

The respective appearance number of display location of promotion information for each group is determined for final display and represented by dᵢ, i=1, 2, 3, . . . , m. An array may be used to implement the operation. FIG. 3 is a flowchart illustrating an example calculation process according to the first example embodiment of the present disclosure.

At 302, the respectively expected number of promotion information for each preference nᵢ and the number of actually returned promotion information cᵢ are used as a vector for input. i=1, 2, . . . , m. m represents a number of obtained preferences.

At 304, an initialization process starts. i is set as 1 and the remaining number left=K. K is the number of display locations at the current page. An empty array Q is set.

At 306, it is determined whether i≦m. If a result is positive, operations at 308 are performed. If a result is negative or i>m, operations at 308 are performed.

At 308, a preset number dᵢ is set as a lesser number between nᵢ and cᵢ. The difference number is calculated as eᵢ=cᵢ−dᵢ. left=left−dᵢ.

At 310, it is determined whether eᵢ>0. If a result is positive, operations at 312 are performed. Otherwise, operations at 316 are performed.

At 312, (i, eᵢ) is placed or pushed into the array Q and then operations at 314 are performed.

At 314, i is added 1 and operations returned to 306.

At 316, it is determined whether left is larger than 0. If a result is positive, operations at 318 are performed. Otherwise, operations at 324 are performed.

At 318, it is determined whether the array Q is not empty. If a result is positive, operations at 320 are performed. Otherwise, operations at 324 are performed.

At 320, an element (k, eₖ) is selected or ejected from the array. k is one of the serial numbers of the elements in Q. k may be, but is not limited to, a serial number corresponding to the preference with the highest weight.

At 322, the preset number of the group corresponding to the selected serial number is revised. dₖ=dₖ+min (eₖ, left) and left=left−min(eₖ, left). Operations return to 316.

At 324, each preset number dᵢ is output. The dᵢ is the final appearance number of display locations of promotion information for each group.

The respective number of actually obtainable promotion information of each preference is assumed as follows.

The respective number of actually obtainable promotion information of the cell phone case is 10.

The respective number of actually obtainable promotion information of the non-woven bag is 3.

The respective number of actually obtainable promotion information of the shrilling chick is 18.

According to the process as shown in FIG. 3, the final respective appearance number of display locations of promotion information for each preference group is as follows:

The respective appearance number of display locations of the cell phone case is 10.

The respective appearance number of display locations of the non-woven bag is 3.

The respective appearance number of display locations of the shrilling chick is 5.

Finally, with respect to the obtained promotion information of each preference, according to the respective appearance number of display locations of promotion information of each preference, the corresponding number of promotion information is selected to display. If, with respect to a preference, the number of actually obtained promotion information is more than the number of the finally determined appearance number of display location for the preference, an example preset strategy for selecting the promotion information for display is to preferentially select the promotion information with higher priority. For example, the number of actually obtainable promotion information of the shrilling chick is 18 while the finally determined appearance number of display locations of the shrilling chick is 5. The obtained 18 promotion information of the shrilling chick may be ranked according to a preset priority. The top 5 promotion information in priority is selected to display. Certainly, some other strategies or methods may be selected. For example, the promotion information that has earlier storage time is preferentially selected. For another example, the promotion information may be randomly selected.

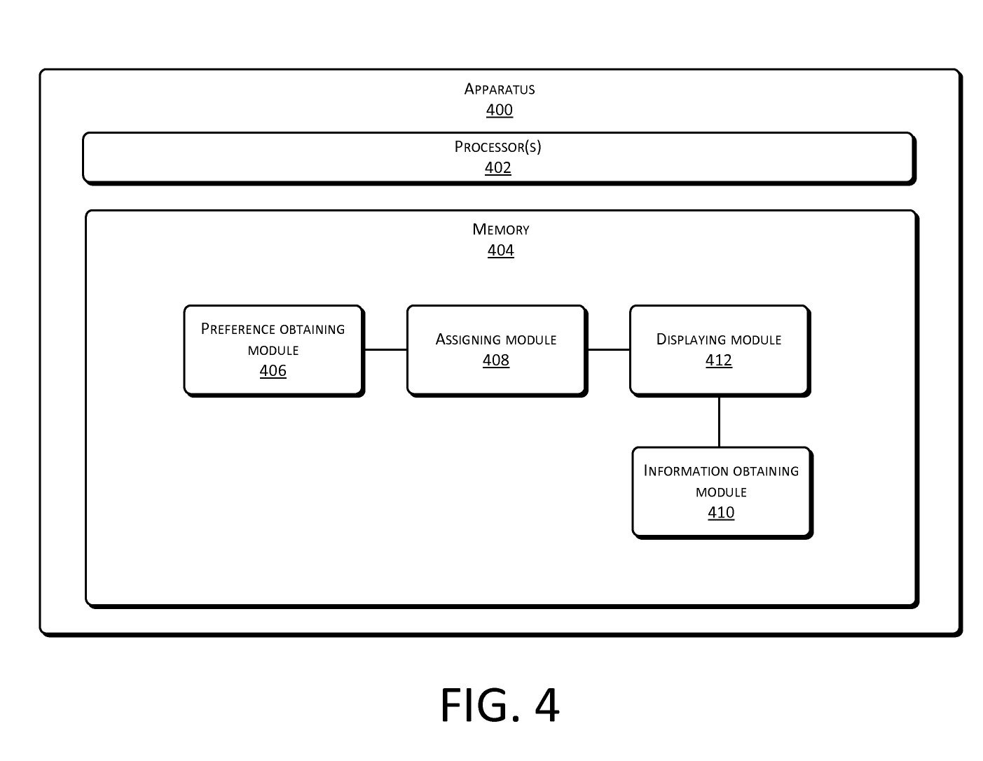

A second example embodiment of the present disclosure also provides an example apparatus for displaying promotion information. FIG. 4 is a schematic diagram illustrating an example apparatus 400 for displaying promotion information according to the second example embodiment of the present disclosure.

The apparatus 400 may include one or more processor(s) 402 and memory 404. The memory 404 is an example of computer-readable media. As used herein, “computer-readable media” includes computer storage media and communication media.

Computer storage media includes volatile and non-volatile, removable and non-removable media implemented in any method or technology for storage of information such as computer-executed instructions, data structures, program modules, or other data. In contrast, communication media may embody computer-readable instructions, data structures, program modules, or other data in a modulated data signal, such as a carrier wave. As defined herein, computer storage media does not include communication media. The memory 404 may store therein program units or modules and program data.

In the example of FIG. 4, the memory 404 may store therein a preference obtaining module 406, an assigning module 408, information obtaining module 410, and a displaying module 412. The preference obtaining module 406 obtains multiple preferences and a respective weight of each preference of a user at a client terminal that visits a current page. For example, the preferences and weights may be obtained according to a user cookie at the client terminal. The assigning module 408 calculates a respectively assigned number of display locations for each preference based on the respective weight of each preference and a number of display locations at the current page. The information obtaining module 410 obtains respective promotion information corresponding to a respective reference. The display module 412 displays or pushes promotion information at the display locations of the current page according to the respectively assigned number of display locations for each preference.

For example, the displaying module 412 may include an adjusting unit and a displaying unit. The adjusting unit adjusts the respective appearance number of display locations for the respective promotion information corresponding to the respective preference based on the respectively assigned number of display locations for the respective preference and a respective number of promotion information that is actually obtained or obtainable corresponding to the respective preference. The displaying unit displays a corresponding number of promotion information for the respective preference at the display locations according to the adjusted respective appearance number of display locations for the respective reference.

For example, the assigning module 408 may include a pre-selecting unit, a first calculating unit, and a second calculating unit. The pre-selecting unit pre-selects a particular preference from the obtained preferences. The first calculating unit, with respect to the other preferences, divides the respective weight of the respective preference by a sum of weights of all preferences, multiplies the obtained quotient with the number of display locations at the current page, and uses the obtained product that is rounded down as the respectively assigned number of display locations of the respective preference. The number of display locations minus the sum of the respectively assigned number of display locations of the other preferences to obtain the respectively assigned number of display locations for the particular preference. The second calculating unit subtracts the sum of the respectively assigned number of display locations of the other preferences from the number of display locations to obtain the respectively assigned number of display locations for the particular preference.

For example, the information obtaining module 410 obtains the respective promotion information corresponding to each preference in parallel.

For example, the adjusting unit may include a pre-setting sub-unit, a remaining location calculating sub-unit, a determining sub-unit, and an adjusting sub-unit.

The pre-setting sub-unit, with respect to each preference, performs the following operations. The pre-setting sub-unit uses a lesser number between the respectively assigned number of display locations and the respective number of promotion information that is actually obtainable as the respective appearance number of display locations for the respective promotion information. If the respective number of promotion information that is actually obtained or obtainable corresponding to the respective preference is higher than the respectively assigned number of display locations, the pre-setting unit calculates a difference value and use the difference value as a respective difference number corresponding to the respective preference.

The remaining location calculating sub-unit calculates a difference between the number of display locations and a sum of the respective appearance number of display locations for each preference to obtain a display location remaining number.

The determining sub-unit starts the adjusting sub-unit if the display location remaining number is larger than 0 and there exists at least one preference with respective difference number, or sends the respective appearance number of display locations of the respective preference to the displaying unit if the display location remaining number is not larger than 0 or there does not exist any respective difference number.

The adjusting sub-unit selects a particular preference with a respective difference number, adds the respective appearance number of display locations of the particular preference with a lesser number between the respective difference number and the display location remaining number to obtain a result to update the respective appearance number of display locations of the particular preference, and then instructs the remaining location sub-unit to re-calculate.

The other details may refer to the examples or alternatives in the first example embodiment of the present disclosure.

A person with ordinary skill in the art should understand that some or all of the above operations or steps may be implemented by using the computer-executable instruction executable by one or more processors to direct relevant hardware. The computer-executable instructions may be stored in computer storage media such as read only memory (ROM), magnetic disk, CD-ROM, etc. Correspondingly, some or all of the modules and units as described in the example embodiments of the present disclosure may be implemented by hardware or software functionality modules. The present disclosure does not restrict any kind of combination of hardware and software.

Certainly, the present disclosure may have some other example embodiments. Without departing the sprit and principle of the present disclosure, a person with ordinary skill in the art may make various corresponding modifications or changes. Such modifications or changes should be regarded as within the protection scope of the present disclosure.

What is claimed is:

1. A method comprising:
obtaining multiple preferences and a respective weight of each preference of a user;
calculating a respectively assigned number of display locations for each preference based on the respective weight of each preference and a number of display locations at a current page;
obtaining respective promotion information corresponding to a respective reference; and
displaying the respective promotion information at the display locations of the current page according to the respectively assigned number of display locations for each preference.

2. The method of claim 1, wherein the obtaining the multiple preferences and the respective weight of each preference of the user comprises obtaining the multiple preferences and the respective weight of each preference of the user according to a user cookie at a client terminal that visits the current page.

3. The method of claim 1, wherein the displaying the respective promotion information at the display locations of the current page according to the respectively assigned number of display locations for each preference comprises:
adjusting a respective appearance number of display locations for respective promotion information corresponding to the respective preference based on the respectively assigned number of display locations for the respective preference and a respective number of promotion information that is actually obtainable corresponding to the respective preference; and
displaying a corresponding number of promotion information for the respective preference at the display locations according to the adjusted respective appearance number of display locations for the respective preference.

4. The method of claim 3, wherein the adjusting comprises:
with respect to each preference,
using a lesser number between the respectively assigned number of display locations and the respective number of promotion information that is actually obtainable as the respective appearance number of display locations for the respective promotion information; and
in response to determining that the respective number of promotion information that is actually obtainable corresponding to the respective preference is higher than the respectively assigned number of display locations, calculating a respective difference value as a respective difference number corresponding to the respective preference;
calculating a difference between the number of display locations and a sum of the respective appearance number of display locations of the multiple preferences to obtain a display location remaining number;
in response to determining that the display location remaining number is larger than 0 and there exists at least one preference with respective difference number,
selecting a particular preference with a respective difference number;
adding the respective appearance number of display locations of the particular preference with a lesser number between the respective difference number and the display location remaining number to obtain a result to update the respective appearance number of display locations of the particular preference.

5. The method of claim 4, further comprising in response to determining that the display location remaining number is not larger than 0 or there does not exist any respective difference number, displaying the corresponding number of promotion information for the respective preference at the display locations according to the adjusted respective appearance number of display locations for the respective preference.

6. The method of claim 1, wherein the calculating the respectively assigned number of display locations for each preference based on the respective weight of each preference and the number of display locations at the current page comprises:
pre-selecting a particular preference from the obtained multiple preferences;
with respect to each of other preferences,
dividing the respective weight of the respective preference by a sum of weights of the multiple preferences to obtain a respective quotient;
multiplying the respective quotient with the number of display locations at the current page to obtain a respective product; and
rounding down the respective product as the respectively assigned number of display locations of the respective preference; and
using the number of display locations to minus the sum of the respectively assigned number of display locations of the other preferences to obtain the respectively assigned number of display locations for the particular preference.

7. The method of claim 1, wherein the obtaining the respective promotion information corresponding to the respective reference comprises obtaining the respective promotion information corresponding to each preference in parallel.

8. An apparatus comprising:
an obtaining module that obtains multiple preferences and a respective weight of each preference of a user;
an assigning module that calculates a respectively assigned number of display locations for each preference based on the respective weight of each preference and a number of display locations at a current page;
an information obtaining module that obtains respective promotion information corresponding to a respective reference; and
a displaying module that displays the respective promotion information at the display locations of the current page according to the respectively assigned number of display locations for each preference.

9. The apparatus of claim 8, wherein the obtaining module obtains the multiple preferences and the respective weight of each preference of the user according to a user cookie at a client terminal that visits the current page.

10. The apparatus of claim 8, wherein the displaying module comprises:
an adjusting unit that adjusts a respective appearance number of display locations for respective promotion information corresponding to the respective preference based on the respectively assigned number of display locations for the respective preference and a respective number of promotion information that is actually obtainable corresponding to the respective preference; and
a displaying unit that displays a corresponding number of promotion information for the respective preference at the display locations according to the adjusted respective appearance number of display locations for the respective preference.

11. The apparatus of claim 10, wherein the adjusting unit comprises:
a pre-setting sub-unit that, with respect to each preference,
uses a lesser number between the respectively assigned number of display locations and the respective number of promotion information that is actually obtainable as the respective appearance number of display locations for the respective promotion information; and
in response to determining that the respective number of promotion information that is actually obtainable corresponding to the respective preference is higher than the respectively assigned number of display locations, calculates a respective difference value as a respective difference number corresponding to the respective preference;
a remaining location calculating sub-unit that calculates a difference between the number of display locations and a sum of the respective appearance number of display locations of the multiple preferences to obtain a display location remaining number;
a determining unit that determines to start an adjusting sub-unit in response to determining that the display location remaining number is larger than 0 and there exists at least one preference with respective difference number; and
the adjusting sub-unit that:
selects a particular preference with a respective difference number; and
adds the respective appearance number of display locations of the particular preference with a lesser number between the respective difference number and the display location remaining number to obtain a result to update the respective appearance number of display locations of the particular preference.

12. The apparatus of claim 11, wherein the adjusting sub-unit further instructs the remaining location sub-unit to re-calculate after the adjusting sub-unit updates the respective appearance number of display locations of the particular preference.

13. The apparatus of claim 10, wherein:
the determining sub-unit determines to send adjusted respective appearance number of display locations for the respective preference to the displaying module in response to determining that the display location remaining number is not larger than 0 or there does not exist any respective difference number.

14. The apparatus of claim 13, wherein the displaying module displays the corresponding number of promotion information for the respective preference at the display locations according to the adjusted respective appearance number of display locations for the respective preference.

15. The apparatus of claim 8, wherein the assigning module comprises:
a pre-selecting unit that pre-selects a particular preference from the obtained multiple preferences;
a first calculating unit that, with respect to each of other preferences,
divides the respective weight of the respective preference by a sum of weights of the multiple preferences to obtain a respective quotient;
multiplies the respective quotient with the number of display locations at the current page to obtain a respective product; and
rounds down the respective product as the respectively assigned number of display locations of the respective preference; and
a second calculating unit that uses the number of display locations to minus the sum of the respectively assigned number of display locations of the other preferences to obtain the respectively assigned number of display locations for the particular preference.

16. The apparatus of claim 8, wherein the obtaining module obtains the respective promotion information corresponding to each preference in parallel.

17. One or more computer storage media stored thereon computer-executable instructions executable by one or more hardware to perform operations comprising:
obtaining multiple preferences and a respective weight of each preference of a user according to a user cookie at a client terminal that visits a current page;
calculating a respectively assigned number of display locations for each preference based on the respective weight of each preference and a number of display locations at the current page;
obtaining respective promotion information corresponding to a respective reference; and
displaying the respective promotion information at the display locations of the current page according to the respectively assigned number of display locations for each preference.

18. The one or more computer storage media of claim 17, wherein the displaying the respective promotion information at the display locations of the current page according to the respectively assigned number of display locations for each preference comprises:
adjusting a respective appearance number of display locations for respective promotion information corresponding to the respective preference based on the respectively assigned number of display locations for the respective preference and a respective number of promotion information that is actually obtainable corresponding to the respective preference; and
displaying a corresponding number of promotion information for the respective preference at the display locations according to the adjusted respective appearance number of display locations for the respective preference.

19. The one or more computer storage media of claim 17, wherein the adjusting comprises:
with respect to each preference,
using a lesser number between the respectively assigned number of display locations and the respective number of promotion information that is actually obtainable as the respective appearance number of display locations for the respective promotion information; and
in response to determining that the respective number of promotion information that is actually obtainable corresponding to the respective preference is higher than the respectively assigned number of display locations, calculating a respective difference value as a respective difference number corresponding to the respective preference;
calculating a difference between the number of display locations and a sum of the respective appearance number of display locations of the multiple preferences to obtain a display location remaining number; and
in response to determining that the display location remaining number is larger than 0 and there exists at least one preference with respective difference number,
selecting a particular preference with a respective difference number; and
adding the respective appearance number of display locations of the particular preference with a lesser number between the respective difference number and the display location remaining number to obtain a result to update the respective appearance number of display locations of the particular preference.

20. The one or more computer storage media of claim 19, further comprising in response to determining that the display location remaining number is not larger than 0 or there does not exist any respective difference number, displaying the corresponding number of promotion information for the respective preference at the display locations according to the adjusted respective appearance number of display locations for the respective preference.
